(19) United States
(12) Patent Application Publication
(10) Pub. No.: US 2019/0102858 A1
(43) Pub. Date: Apr. 4, 2019

(54) SYSTEM AND METHOD FOR AGGREGATING AND COMMUNICATING PERSONAL MODE OF TRANSPORTATION INFORMATION

(71) Applicant: Leon Capital Group, LLC, Dallas, TX (US)

(72) Inventors: Robert Nathaniel Pivnick, Dallas, TX (US); Michael Earl Sutton, Dallas, TX (US)

(21) Appl. No.: 16/149,599

(22) Filed: Oct. 2, 2018

Related U.S. Application Data
(60) Provisional application No. 62/566,747, filed on Oct. 2, 2017.

(51) Int. Cl. G06Q 50/30; G06Q 10/02; G06Q 30/02; G06Q 30/06; H04L 29/08; G01C 21/34

(52) U.S. Cl. CPC G06Q 50/30; G06Q 10/02; G06Q 30/0261; G01C 21/3484; H04L 67/18; G06Q 30/0283; G01C 21/3423; G06Q 30/0639

(57) ABSTRACT

Embodiments relate generally to systems and method for locating and obtaining a personal mode of transportation, such as a bicycle, motorcycle, moped, or scooter. A system may comprise at least one computing platform; and a computer program including a computing platform application on a non-transitory, tangible computer readable medium such as a memory, wherein the application performs a sequence of functions on the computing platform, and wherein the computing platform application is configured to generate a request for information on a location of available modes of personal transportation.

### CROSS-REFERENCE TO RELATED APPLICATIONS

The present application claims priority to U.S. Provisional Patent Application Ser. No. 62/566,747, filed Oct. 2, 2017, by Robert Pivnick, et al. and entitled “System and Method for Aggregating and Communicating Personal Mode of Transportation Information” which is incorporated herein by reference as if reproduced in its entirety.

### FIELD OF THE INVENTION

A personal mode of transportation, e.g., a bicycle, motorcycle, moped, or scooter, for traveling short distances provides convenience, efficiency, and an opportunity to enjoy the outdoors and one's surroundings.

### BACKGROUND

Recently, many providers such as V Bike™, Citi Bike™, and Lime™ have begun providing various types of personal modes of transportation to users wherein the users only need to locate the personal mode of transportation, pay the required fee (e.g., via a smart phone application or via direct pay at the personal mode of transportation), and then ride the personal mode of transportation to the user's destination and leave the personal mode of transportation at the user's destination (i.e., no obligation to return the personal mode of transportation to where user located it). For ease of disclosure, the terms “mode of personal transportation” and “modes of personal transportation” shall be deemed defined terms which encompass rentable and/or borrowable bicycles, scooters, motorcycles, mopeds, electric scooters, and motor bikes.

The modes of personal transportation are equipped with tracking devices which allow providers (e.g., the rental businesses) to locate their equipment and to provide users of their services (e.g., the rental businesses' smart phone applications) the ability to locate, reserve, and/or pay for the use of the modes of personal transportation.

One of the challenges of using the described rental modes of personal transportation is that each of the different providers uses their own proprietary applications; therefore, in order for a user to find the closest rentable mode of personal transportation, the user may have to search a multitude of applications and perform their own analysis as to the closest mode of personal transportation. The user may also have to compare the different pricing structures for the multitude of providers to determine what rentable/borrowable mode of personal transportation is the best option (e.g., farther away but cheaper or closer and more expensive). What is needed is a single application that will aggregate all of the surrounding mode of personal transportation information from all of the providers and perform an analysis of the aggregated information (e.g., based on user defined preferences or pre-defined preferences) to allow the user to locate the best mode of personal transportation for the user's needs.

### SUMMARY

In an embodiment, a method may comprise encoding a computer program; forming a computing platform application on a non-transitory tangible computer readable medium such as a memory; performing a sequence of functions on a computing platform comprising hardware and software, where the computing platform can include a mobile phone, a tablet, a watch, or a personal computer; and activating, by a user, the application to transmit a request for information on a location of available modes of personal transportation.

In an embodiment, a system may comprise at least one computing platform; and a computer program including a computing platform application on a non-transitory tangible computer readable medium such as a memory, wherein the application performs a sequence of functions on the computing platform, and wherein the computing platform application is configured to generate a request for information on a location of available modes of personal transportation.

In an embodiment, a method may comprise receiving, by an aggregator processor, information from one or more modes of personal transportation provider applications; updating, by the aggregator processor, on a real time basis, an available modes of personal transportation database with the information from the one or more provider applications; receiving a computing platform application request from a user via a computing platform; retrieving, by the aggregator processor, available mode of personal transportation information from the available modes of personal transportation database; and transmitting a response to the computing platform application request, wherein the transmitted response includes information on real time available modes of personal transportation, rental fees, and advertising promotions proximate to the location of the computing platform.

### BRIEF DESCRIPTION OF THE DRAWINGS

Further features of the present disclosure are set forth in the detailed description and in the drawings figures. Referring to the drawings in which like reference numbers represent corresponding parts throughout.

FIG. 1 illustrates a mode of personal transportation information aggregator system according to an embodiment of the disclosure.

FIG. 2 illustrates a computing platform transmitting a request for an available mode of personal transportation to aggregator processor according to an embodiment of the disclosure.

FIG. 3 illustrates a computing platform, receiving a transmitted response on an available mode of personal transportation from an aggregator processor, and displaying information on available modes of personal transportation according to an embodiment of the disclosure.

FIG. 4 is a block diagram of a computer system according to certain embodiments of the disclosure.

Each figure shown in this disclosure shows a variation of an aspect of the embodiments presented, and only differences will be discussed in detail.

### DETAILED DESCRIPTION

To address solutions to the problem detailed above, the present disclosure provides a method, apparatus and system where a plurality of provider applications are monitored, analyzed, and the aggregated information relating to all available modes of personal transportation from all providers is provided to a user.

Furthermore, a software application encoded on a memory on a computer comprising hardware and software, e.g., a mobile phone, is configured to be activated by a user inquiring about an available mode of personal transportation, where the real time location of the user (e.g., via mobile phone GPS location or wireless locating) is utilized to provide the most convenient mode of personal transportation location results. The inquiry is transmitted to a personal modes of transportation information aggregator system comprising hardware and software, with access to the database with the stored information on the available modes of personal transportation.

The personal modes of transportation information aggregator system (hereinafter “aggregator system”) then provides a response that is received by the software application including available modes of personal transportation, their location, pricing, and other information associated with available modes of personal transportation.

The aggregator system is further configured to keep track of advertising promotions that are transmitted and received by the software application on behalf of the providers or other advertisers with a report on transmissions and associated invoice for such advertisement.

Furthermore, the software application is configured to enable the user to transmit a reservation inquiry to the aggregator system, authorizing payment of a fee by the user. Upon receipt of the payment, the aggregator system communicates with the provider's system in order for the provider's system to preclude the user's selected mode of personal transportation from being reserved or rented by other inquiring software applications, e.g., the provider's system changes the status of the available mode of personal transportation to one of a reserved mode of personal transportation. The aggregator system and the provider's system will perform back end settlement on fees received.

In one embodiment a method describes encoding a computer program forming a computing platform application on a non-transitory, tangible computer readable medium such as a memory. The application further may cause the computing platform, comprising hardware and software, to perform a sequence of functions, wherein the computing platform can include a mobile phone, a tablet, watch, or a personal computer.

The operation of the computer platform application includes a user who activates the application to transmit a request for information querying as to a location of available modes of personal transportation, possibly including in the request, a cost estimate for each available mode of personal transportation. The request also may include a location for user, which is either proximate to a real time location of the user or a future location of the user. The request is sent to an aggregator processor.

The method further describes a system of maps (both street and satellite) on which the locations of available modes of personal transportation can be displayed to the user.

The method further describes that the application further provides distance information and an estimated travel time on foot, by a car, or a shuttle to a user selected available mode of personal transportation.

In another embodiment a system is described. The system includes a computing platform that can be a mobile phone, a tablet, a watch, or a personal computer. The system further includes a computer program including a computing platform application on a tangible computer readable medium such as a memory, where the application performs a sequence of functions on the computing platform.

The system further includes an aggregator processor, a database including data on available modes of personal transportation, any associated rental fees, and advertising promotions.

The system further describes that the aggregator processor communicates with the computing platform application, and is also linked to the database that includes information on available modes of personal transportation.

In yet another embodiment a method is described that provides that the aggregator processor updates, on a real time basis, an available mode of personal transportation database with the information from the provider's applications and associated information. The aggregator processor then retrieves available mode of personal transportation information from the available mode of personal transportation database and transmits a response to the computing platform application request. The transmitted response includes information on real time available modes of personal transportation, rental fees, and advertising promotions proximate to the location of the computing platform. The computing platform may intake the provided information and perform a separate analysis of the information based on user defined preferences and/or pre-defined preferences. In an embodiment, the computing platform and/or aggregator processor may provide information regarding which mode of personal transportation, e.g., rentable and/or borrowable bicycles, scooters, motorcycles, mopeds, electric scooters, and motor bikes, would be the most user-appreciated mode of arriving at a user's desired destination. Such information may be provided based on user preferences stored in memory accessible by the computing platform and/or aggregator processor. Such user preferences may include a user's proclivity to: travel the shortest distance; avoid traffic; avoid crowds; pay the least in fees; avoid pedestrians; have a safe experience, have a scenic route; travel in the quickest time (or via fastest mode of personal transportation); and to prefer the most environmentally friendly modes of personal transportation. In an embodiment, the computing platform (executing specific programmed commands) and/or aggregator processor (executing specific programming instructions) may determine the best personal mode of transportation in response to a request based on a stored user profile of the user. For example, the stored user profile may indicate specific weightings of the user's preferences which may be utilized to determine which mode of personal transportation would best serve the user's interests at the time of the request and/or time of the user's desired use of the personal mode of transportation.

The present disclosure relates to systems and methods for identifying an available mode of personal transportation and reporting of the same, and in particular to a software application on a mobile phone or a computer initiating a request for information on available mode of personal transportation and an information accumulator, analyzer, data storage, and communication system responding to the request.

Generally the present disclosure describes a software application titled Eureka, that is a computer program encoded on a on a non-transitory, tangible computer readable medium for performing a sequence of functions on a computing platform including a mobile phone, a tablet, a watch, or a personal computer, functioning to assist a user in finding an available rentable/borrowable mode of personal transportation close to its location.

A user uses the Eureka application to locate modes of personal transportation proximate to its current location (or a provided or chosen location) and transmits a request for a display or indication of available modes of personal transportation to an aggregator processor.

The aggregator processor searches a database that contains the location of available modes of personal transportation and associated information with the available modes of personal transportation (e.g., provider, pricing, and special offers), and selects a plurality of available modes of personal transportation which are closest to the user's current or specified location and transmits a response with the information to the computing platform that initiated the request. In an embodiment, the selected plurality of available modes of personal transportation comprises rentable and/or borrowable bicycles, scooters, motorcycles, mopeds, electric scooters, and motor bikes, from which the user will decide as to which mode of personal transportation it will choose, after the user has been presented options for the available modes of personal transportation, wherein the options may be present to the user at the computing platform in a which is determined based on stored user preferences.

The database of available modes of personal transportation is continuously updated on a real time basis by the same aggregator processor. The aggregator processor is in communication with (or independently surveils) all relevant providers' systems and/or applications (e.g., providers which have indicated they service an area which includes or is closely proximate to the current or indicated location of the user). The aggregator processor uses the information collected from the providers to maintain its database of available modes of personal transportation.

The aggregator processor uses the information from database on available modes of personal transportation to provide a response to the request for available modes of personal transportation.

Once the computing platform receives the transmitted response from the aggregator processor, the location of available modes of personal transportation is displayed on the computing platform and/or audio broadcasted. The providers, by paying an advertisement fee, can arrange for the information on their presented/available modes of personal transportation to further include membership rewards and advertisement promotions to be transmitted to and displayed by the Eureka application for the benefit of a user searching for a rentable mode of personal transportation.

The user can select one of the available modes of personal transportation provided by the response from the aggregator processor and application will display a direction and/guide to the selected available mode of personal transportation. The application will further display a distance and time that it will take the user to go from the user's location to the selected mode of personal transportation.

The user can further reserve the selected available mode of personal transportation by authorizing payment of a fee through the Eureka application. This reservation will preclude the aggregator processor and provider systems from including the reserved selected mode of personal transportation in responses to other users requesting an available mode of personal transportation.

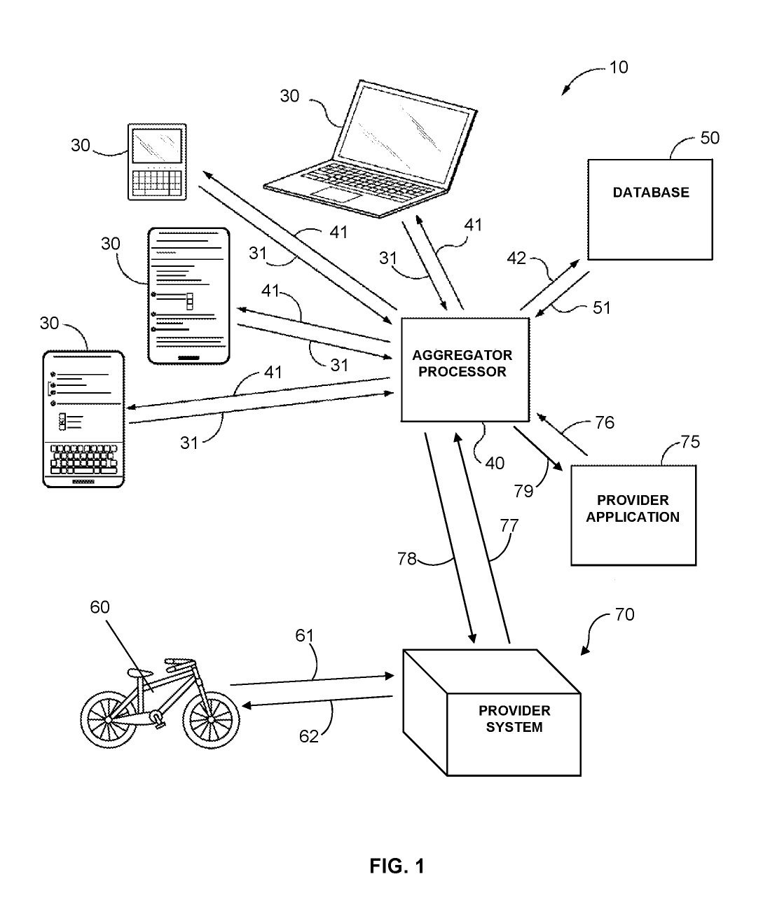

Referring to FIG. 1, the overall hardware systems 10 and general functions comprising the Eureka application 20 are detailed. The computing platforms 30 including a mobile phone, a tablet, and a personal computer are shown with the Eureka application 20 encoded on an onboard non-transitory tangible computer readable medium in communication with an aggregator processor 40. Where the computing platforms 30 transmit request 31 for available modes of personal transportation 60 to the aggregator processor 40, and the aggregator processor 40 transmits responses 41 back to the computing platforms 30.

The aggregator processor 40 in turn is in communication with the database 50 on available modes of personal transportation, both updating the database 50 on a real time basis with available modes of personal transportation locations and associated information, and searching the database 50 on available modes of personal transportation for information to provide a response to the computing platform 30 requests 31 for available modes of personal transportation. The database 50 on available modes of personal transportation is maintained and updated in real time via communications 76, 77 received by the aggregator processor from a modes of personal transportation provider system 70 and/or a provider application 75. The modes of personal transportation provider system 70 communicates 61, 62 with its modes of personal transportation to maintain and update its internal databases of modes of personal transportation information.

FIG. 1 further shows that the information in the database 50 on available modes of personal transportation is based on information communicated 76 from provider systems 70 or collected 77 from provider applications 75.

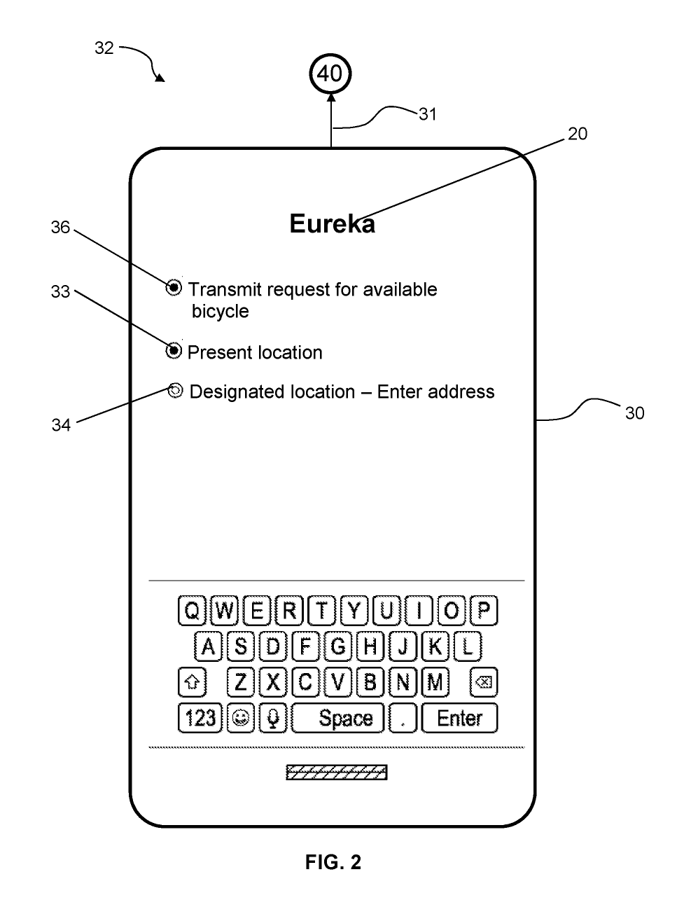

Referring to FIG. 2, a computing platform 30 is shown along with the Eureka application 20 request transmitting display 32. The display illustrates the activating button 36 for transmitting a request 31 for an available modes of personal transportation 60.

The display further illustrates button 34 identifying the location, where the available mode of personal transportation 60 is requested. One button identifies a present location 33 of the user. This location is provided to the Eureka application 20 by a triangulation of cellular towers identifying the location 33 of the computing platform 30 (e.g., when the computing platform comprises a mobile phone), or in other situations, by a global positioning system (GPS) available on the computing platform. The GPS will locate the present location 33 of the computing platform 30. There are other methods also available for locating a computing platform such as using radio frequencies emitting from radio station. In situations where the computing platform also has a map application such as a GOOGLE MAP™, YAHOO MAP™ or other map applications, the Eureka application 20 may get input as to the location 33 of the computing platform 30 using the map application.

A second button is provided on the Eureka application 20 display for specifying a designated user location 34, the location where the available mode of personal transportation is requested. A user may enter a designated location address by manipulating an input device on the computing platform 30. This location may be a “chosen” location, a future location, a pre-defined location, and/or a designated location.

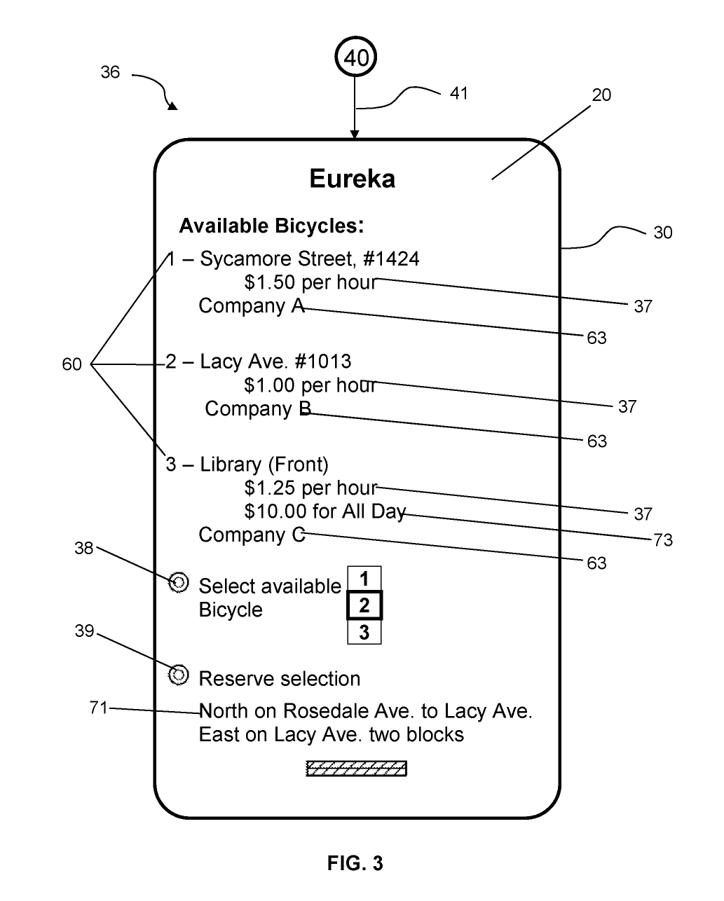

Referring to FIG. 3, a computing platform 30 is shown along with the Eureka application 20 received response display 36. The display 36 illustrates the transmitted response 41 of the aggregator processor 40 to the Eureka application 20, showing a list of available modes of personal transportation 60 and their corresponding providers 63. The information on available modes of personal transportation 60 may further include an associated rental fee 37 and provider advertisement promotions 73. The Eureka application 20 further provides for an audio broadcast of the available modes of personal transportation 60.

The Eureka application 20 received response display 36 further provides a button 38 for selecting an available mode of personal transportation 60. Upon selecting of one of the available modes of personal transportation 60 the Eureka application 20 provides a map and/or guide 71 to the selected available mode of personal transportation 60. In situation where the user had specified a designated location 34 for an available mode of personal transportation 60, the Eureka application 20 will further provide a map and/or guide 71 from the selected available mode of personal transportation 60 to the designated location 34.

The Eureka application 20 further provides a button 39 for reserving a selected available mode of personal transportation 60. By reserving a selected mode of personal transportation 60 the user authorizes payment of a fee 37, and the Eureka application 20 transmits a command to the aggregator processor 40. The command identifies the reserved available mode of personal transportation 60 to the aggregator processor 40, wherein the aggregator processor 40 can exclude the information of that mode of personal transportation from aggregator processor's 40 responses 41 to other Eureka application 20 requests for available modes of personal transportation 60 and directs the aggregator processor 40 to communicate with the mode of personal transportation's provider 78 or provider application 79 so that the modes of personal transportation's provider can also exclude that mode of personal transportation from the provider's database of available modes of personal transportation.

Upon receipt of payment from the user, the aggregator processor 40 acts to ensure that the provider is compensated in an amount equal to or otherwise agreed upon for the use of its mode of personal transportation. It is foreseen that providers will pay the supplier of the Eureka application 20 a commission or flat fee for every provider mode of personal transportation which is rented via the Eureka application 20.

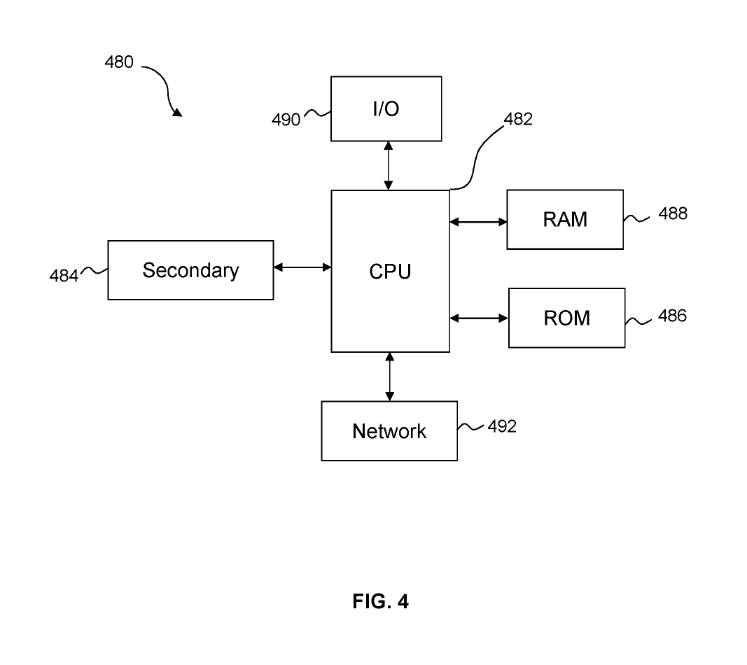

FIG. 4 illustrates a computer system 480 suitable for implementing one or more embodiments disclosed herein. For example, the system discussed above may be implemented in a form substantially similar to that of the computer system 480 and the methods disclosed herein may be implemented by a computer system 480 programmed with executable instructions. Computer system 480 includes a processor 482 (which may be referred to as a central processor unit or CPU) that is in communication with memory devices including secondary storage 484, read only memory (ROM) 486, random access memory (RAM) 488, input/output (I/O) devices 490, and network connectivity devices 492. The processor 482 may be implemented as one or more CPU chips.

It is understood that by programming and/or loading executable instructions onto the computer system 480, at least one of the CPU 482, the RAM 488, and the ROM 486 are changed, transforming the computer system 480 in part into a particular machine or apparatus (e.g., a special purpose machine) having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 484 is typically comprised of one or more disk drives or tape drives and is used for non-volatile storage of data and as an over-flow data storage device if RAM 488 is not large enough to hold all working data. Secondary storage 484 may be used to store programs which are loaded into RAM 488 when such programs are selected for execution. The ROM 486 is used to store instructions and perhaps data which are read during program execution. ROM 486 is a non-volatile memory device which typically has a small memory capacity relative to the larger memory capacity of secondary storage 484. The RAM 488 is used to store volatile data and perhaps to store instructions. Access to both ROM 486 and RAM 488 is typically faster than to secondary storage 484. The secondary storage 484, the RAM 488, and/or the ROM 486 may be referred to in some contexts as computer readable storage media and/or non-transitory computer readable media.

I/O devices 490 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 492 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 492 may enable the processor 482 to communicate with the Internet or one or more intranets. With such a network connection, it is contemplated that the processor 482 might receive information from the network, or might output information to the network in the course of performing the above-described method steps. Such information, which is often represented as a sequence of instructions to be executed using processor 482, may be received from and outputted to the network, for example, in the form of a computer data signal embodied in a carrier wave.

Such information, which may include data or instructions to be executed using processor 482 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 482 executes instructions, codes, computer programs, scripts which it accesses from hard disk, floppy disk, optical disk (these various disk based systems may all be considered secondary storage 484), ROM 486, RAM 488, or the network connectivity devices 492. While only one processor 482 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 484, for example, hard drives, floppy disks, optical disks, and/or other device, the ROM 486, and/or the RAM 488 may be referred to in some contexts as non-transitory instructions and/or non-transitory information.

In an embodiment, the computer system 480 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 480 to provide the functionality of a number of servers that is not directly bound to the number of computers in the computer system 480. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

As various modifications could be made in the disclosed system, components, the methods of use herein described and illustrated without departing from the scope of the present disclosure, it is intended that all matter contained in the foregoing description or shown in the accompanying figures shall be interpreted as illustrative rather than limiting. Thus, the breadth and scope of the present disclosure should not be limited by any of the above described exemplary embodiments, but should be defined only in accordance with the following claims appended hereto and their equivalents.

Having described various devices and methods herein, exemplary embodiments or aspects can include, but are not limited to:

In a first embodiment, a method may comprise encoding a computer program; forming a computing platform application on a non-transitory, tangible computer readable medium such as a memory; performing a sequence of functions on a computing platform comprising hardware and software, wherein the computing platform can include a mobile phone, a tablet, a watch, or a personal computer; and activating, by a user, the application to transmit a request for information on a location of available personal modes of transportation.

A second embodiment can include the method of the first embodiment, wherein the request includes a future location of the user.

A third embodiment can include the method of the first or second embodiments, wherein the request includes a real time location of the user.

A fourth embodiment can include the method of any of the first through third embodiments, wherein the request is sent to an aggregator processor.

A fifth embodiment can include the method of any of the first through fourth embodiments, further comprising including in the request a cost estimate for each available bicycle.

A sixth embodiment can include the method of any of the first through fifth embodiments, further comprising displaying a system of maps on which the locations of available bicycles can be displayed to the user.

A seventh embodiment can include the method of any of the first through sixth embodiments, further comprising providing, by the application, distance information and an estimated travel time on foot, by a car, or a shuttle to a user selected available bicycle.

In an eighth embodiment, a system may comprise at least one computing platform; and a computer program including a computing platform application on a tangible computer readable medium such as a memory, wherein the application performs a sequence of functions on the computing platform, and wherein the computing platform application is configured to generate a request for information on a location of available modes of personal transportation.

A ninth embodiment can include the system of the eighth embodiment, further comprising an aggregator processor configured to communicate with the computing platform; and a database including data on available modes of personal transportation, any associated rental fees, and advertising promotions.

A tenth embodiment can include the system of the eighth or ninth embodiment, wherein the aggregator processor is configured to communicate with the computing platform application, and wherein the aggregator processor is linked to the database that includes information on available modes of personal transportation.

An eleventh embodiment can include the system of any of the eighth through tenth embodiments, wherein the computing platform comprises one or more of the following: a user device, a mobile phone, a tablet, a watch, and a personal computer.

A twelfth embodiment can include the system of any of the eighth through eleventh embodiments, wherein the computing platform comprises a display configured to display a system of maps on which the locations of available bicycles can be displayed to the user.

A thirteenth embodiment can include the system of any of the eighth through twelfth embodiments, wherein the computing platform comprises a location module configured to determine a location of the computing platform.

A fourteenth embodiment can include the system of the thirteenth embodiment, wherein the request comprises a real time location of the computing platform.

A fifteenth embodiment can include the system of the thirteenth or fourteenth embodiment, wherein the request comprises a future location of the computing platform.

In a sixteenth embodiment, a method may comprise receiving, by an aggregator processor, information from one or more modes of personal transportation provider applications; updating, by the aggregator processor, on a real time basis, an available mode of personal transportation database with the information from the one or more provider applications; receiving a computing platform application request from a user via a computing platform; retrieving, by the aggregator processor, available mode of personal transportation information from the available mode of personal transportation database; and transmitting a response to the computing platform application request, wherein the transmitted response includes information on real time available modes of personal transportation, rental fees, and advertising promotions proximate to the location of the computing platform.

A seventeenth embodiment can include the method of the sixteenth embodiment, further comprising receiving, by the computing platform, the provided information; and performing, by the computing platform, a separate analysis of the information based on at least one of user defined preferences and pre-defined preferences.

An eighteenth embodiment can include the method of the sixteenth or seventeenth embodiments, wherein the request includes a current location of the computing platform.

A nineteenth embodiment can include the method of any of the sixteenth through eighteenth embodiments, wherein the request includes a chosen location from the computing platform.

A twentieth embodiment can include the method of any of the sixteenth through nineteenth embodiments, further comprising directing a user to a specific mode of personal transportation chosen by the user from the real time available modes of personal transportation; completing a transaction to rent the specific mode of personal transportation; and indicating to user when the rental period has ended.

What is claimed is:

1. A method comprising:
encoding a computer program;
forming a computing platform application on a tangible computer readable medium such as a memory; wherein the computing platform application causes a computing platform to perform a sequence of functions, wherein the computing platform can include a mobile phone, a tablet, a watch, or a personal computer; and wherein the computing platform application transmits a request for information on a location of available modes of personal transportation.

2. The method of claim 1, wherein the request includes a chosen location of a user.

3. The method of claim 1, wherein the request includes a real time location of a user.

4. The method of claim 1, wherein the request is sent to an aggregator processor.

5. The method of claim 1, wherein the request further comprises a cost estimate for each the available modes of personal transportation.

6. The method of claim 1, further comprising displaying a system of maps on which the locations of available modes of personal transportation can be displayed to a user.

7. The method of claim 1, further comprising providing, by the computing platform application, distance information and an estimated travel time on foot, by a car, or a shuttle to a user selected available mode of personal transportation.

8. A system comprising:
at least one computing platform; and
a computer program including a computing platform application on a non-transitory tangible computer readable medium such as a memory, wherein the computing platform application performs a sequence of functions on the computing platform, and wherein the computing platform application is configured to generate a request for information on a location of available modes of personal transportation.

9. The system of claim 8, further comprising:
an aggregator processor configured to communicate with the computing platform; and
a database including data on available modes of personal transportation, any associated rental fees, and advertising promotions.

10. The system of claim 8, wherein the aggregator processor is configured to communicate with the computing platform application, and wherein the aggregator processor is linked to a database that includes information on available modes of personal transportation.

11. The system of claim 8, wherein the computing platform comprises one or more of the following: a user device, a mobile phone, a tablet, a watch, and a personal computer.

12. The system of claim 8, wherein the computing platform comprises a display configured to display a system of maps on which the locations of available modes of personal transportation can be displayed to a user.

13. The system of claim 8, wherein the computing platform comprises a location module configured to determine a location of the computing platform.

14. The system of claim 13, wherein the request comprises a real time location of the computing platform.

15. The system of claim 13, wherein the request comprises a chosen location of the computing platform.

16. A method comprising:
receiving, by an aggregator processor, information from one or more modes of personal transportation provider applications;
updating, by the aggregator processor, on a real time basis, an available modes of personal transportation database with the information from the one or more provider applications;
receiving a computing platform application request from a user via a computing platform;
retrieving, by the aggregator processor, available modes of personal transportation information from the available modes of personal transportation database; and
transmitting a response to the computing platform application request, wherein the transmitted response includes information on real time available modes of personal transportation, rental fees, and advertising promotions proximate to the location of the computing platform.

17. The method of claim 16, further comprising:
receiving, by the computing platform, provided information; and
performing, by the computing platform, a separate analysis of the information based on at least one of user defined preferences and pre-defined preferences.

18. The method of claim 16, wherein the computing platform application request includes a current location of the computing platform.

19. The method of claim 16, wherein the computing platform application request includes a chosen location from the computing platform.

20. The method of claim 16, further comprising:
directing a user to a specific mode of personal transportation chosen by the user from the real time available modes of personal transportation;
completing a transaction to rent the specific mode of personal transportation; and
indicating to user when the rental period has ended.
